(19) United States
(12) Patent Application Publication
(10) Pub. No.: US 2009/0201537 A1
(43) Pub. Date: Aug. 13, 2009

(54) IMAGE FORMING APPARATUS

(75) Inventor: Takeshi Araya, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/269,165

(22) Filed: Nov. 12, 2008

(30) Foreign Application Priority Data
Feb. 7, 2008 (JP) 2008-027476

(51) Int. Cl. G06F 3/12

(52) U.S. Cl. 358/1.15

(57) ABSTRACT

An image forming apparatus includes: a data reception unit for receiving data sent from another electronic device via a predetermined network; a state detection unit for detecting a current status regarding at least an image forming operation; a data storage unit for storing a plurality of image data corresponding to a plurality of states beforehand; a data selection unit for selecting, based on the current status detected by the state detection unit, at least one of the plurality of the image data stored by the data storage unit; and a data transmission unit for transmitting, when a predetermined request is received from the another electronic device via the predetermined network, the image data selected by the data selection unit to the another electronic device according to the predetermined request.

### INCORPORATION BY REFERENCE

This application is based upon and claims the benefit of priority from the corresponding Japanese Patent Application No. 2008-027476, filed Feb. 7, 2008, the entire contents of which is incorporated herein by reference.

### BACKGROUND

1. Field of the Invention

The present invention relates to image forming apparatus such as printers or copying machines that are connected to, for example, a network, a facsimile transceiver, a complex machine equipped with such functions, or a multifunction peripheral.

2. Description of the Related Art

Conventionally, it is known to use an icon in a computer device to display the status of a printer connected to a network. Using this technology, after reception of status information sent from the printer of the computer device, such as a personal computer, icon data previously stored in the computer device is selected to display the data on a display screen. In this type of system, the icon data is selected according to the status information (color/monochrome, on-line/off-line, or the like) of the printer. Thus, a user of the computer device may be able to determine the status of the printer by viewing the displayed icon.

### SUMMARY

The present invention provides a technology which can reduce the management loads of icon data, in an embodiment, to the greatest extent as possible.

The present invention is directed to image forming apparatus which form an image based on print data sent from another electronic device via a predetermined network. According to an embodiment of the present invention, the image forming apparatus includes: a state detection unit for detecting a current status of at least an image forming operation; a data storage unit for storing, beforehand, a plurality of image data corresponding to a plurality of states; a data selection unit for selecting, based on the current status detected by the state detection unit, at least one of the plurality of the image data stored by the data storage unit; and a data transmission unit for transmitting, when a predetermined request comes from the other electronic device via the network, the image data selected by the data selection unit to the other electronic device according to the predetermined request.

As described above, the image forming apparatus according to an embodiment of the present invention, has image data of its own, selects appropriate image data according to the detected current status, and transmits this selected image data to the electronic device when requested. The electronic device can control the contents to be displayed (e.g., a display that visually conveys network structure) by using the received image data. Thus, the electronic device (e.g., a personal computer) of the network does not have to retain each image data (an icon or the like), thereby reducing management loads. Even when a new image forming apparatus is added onto the network, or when an existing image forming apparatus is removed, since the image forming apparatus itself retains the image data, image data does not have to be installed in the electronic device, nor does unnecessary image data have to be removed.

Additional features and advantages are described herein, and will be apparent from the following Detailed Description and the figures.

### BRIEF DESCRIPTION OF THE FIGURES

In the accompanying drawings:

FIG. 1 is a schematic block diagram illustrating a network environment to which an image forming apparatus is connected according to an embodiment of the present invention;

FIG. 2 is a schematic diagram illustrating an example of a configuration where a plurality of image forming apparatuses are connected to the network according to an embodiment of the present invention;

FIGS. 3A to 3C are diagrams each illustrating an example of where image data is combined with icon data according to an embodiment of the present invention;

FIG. 4 is a diagram illustrating an example of an image displayed in a display device of a personal computer according to an embodiment of the present invention;

FIG. 5 is a diagram illustrating an example where character information is added to the image data according to an embodiment of the present invention; and

FIG. 6 is a diagram illustrating another example of a display where the structure of the network is displayed on the personal computer according to an embodiment of the present invention.

### DETAILED DESCRIPTION

An embodiment of the present invention will be described.

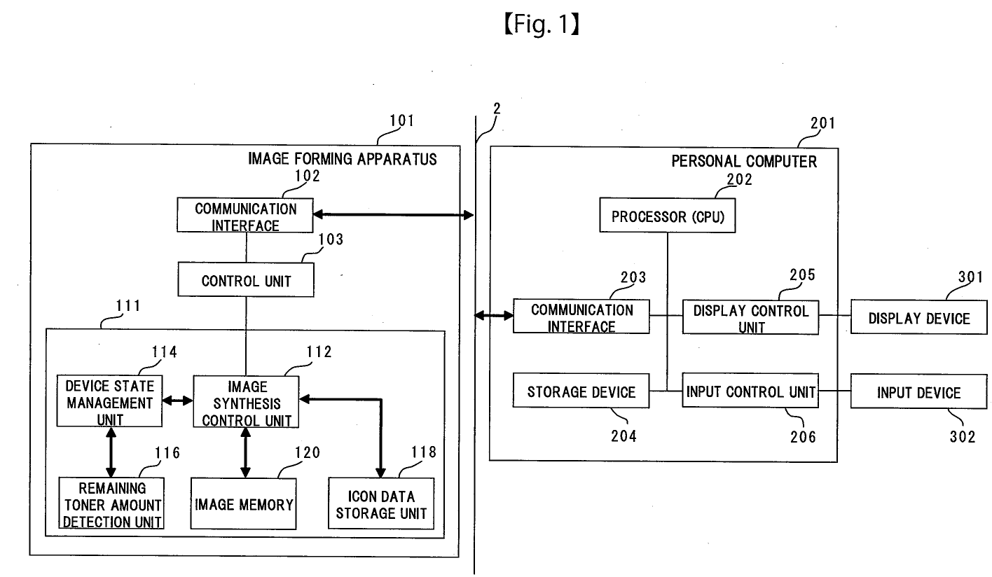

FIG. 1 is a schematic block diagram illustrating a network environment to which an image forming apparatus 101, according to an embodiment of the invention, is connected. The image forming apparatus 101 is connected to a network 2, such as a local area network (LAN). As an example of an electronic device, a personal computer 201 is also connected to the network 2.

First, an embodiment of a configuration of the image forming apparatus 101 will be described. The image forming apparatus 101 is a network-compatible device, for example, a network printer. To function as a printer, the image forming apparatus 101 incorporates a print engine (not illustrated). The print engine includes a photosensitive drum (not illustrated), a charger (not illustrated), an exposure unit (not illustrated), and a developing unit (intermediate transfer belt in the case of color printer) (not illustrated). The image forming apparatus 101 further includes a paper feeder (not illustrated).

It should be noted that a network printer is set forth by way of example. The image forming apparatus 101 may also be a network-compatible digital complex machine or a network-compatible multifunction peripheral (MFP). In this case, the image forming apparatus 101 further includes an image reading unit. The image reading unit incorporates, in addition to, for example, a scanning optical system on which a scanner lamp and a mirror are mounted, a condenser lens, and an optical element such as a CCD. The image reading unit may further include an automatic document feeder (ADF).

The image forming apparatus 101 is configured to operate in a network environment. Specifically, the image forming apparatus 101 includes a communication interface 102 (data reception unit and data transmission unit), a control unit 103, and a response management unit 111. The response management unit 111 includes an image synthesis control unit 112 (data selection unit), a device state management unit 114 (state detection unit), a remaining toner amount detection unit 116, an icon data storage unit 118 (data storage unit), and an image memory 120.

The communication interface 102 is a communication adaptor, for connection with the network 2, and its driver is installed in, for example, the control unit 103. The control unit 103 functions as a computer, and is incorporated in the image forming apparatus 101 in the form of, for example, an electronic circuit board. In the circuit board, a processor (central processing unit (CPU)) and necessary memories (read-only memory (ROM), random-access memory (RAM), and the like) are mounted. The control unit 103 functions to control not only communication that is performed by the communication interface 102, but, also various processes or operations that are performed by the image forming apparatus 101.

The image synthesis control unit 112 also functions as a computer. The image synthesis control unit 112 may be a circuit board equipped with a dedicated processor or memory, or a part of the system resources of the control unit 103 may be used as the image synthesis control unit 112. In any case, the image synthesis control unit 112 functions to generate (synthesize) image data based on a command from the control unit 103.

Detection of Status

The device state management unit 114 also functions simply as a computer. The device state management unit 114 manages (detects) a status of the image forming apparatus 101 by using, for example, a detection signal from the remaining toner amount detection unit 116. Specifically, the remaining toner amount detection unit 116 generates a detection signal corresponding to the amount of toner remaining in a toner container (not illustrated), and transmits the detection signal to the device state management unit 114. As is well known, the amount of toner remaining can be optically detected by using, for example, a photosensor. The device state management unit 114 monitors the detection signal from the remaining toner amount detection unit 116 at, for example, a fixed interrupt cycle, to thereby execute a program for monitoring in real time the amount of toner currently remaining. The device state management unit 114 supplies status information regarding the amount of toner currently remaining to the image synthesis control unit 112.

Full-Color Toner

The image forming apparatus 101 may be used for monochrome printing and full-color printing. When the image forming apparatus 101 is used for full-color printing, the remaining toner amount detection unit 116 can be used to detect the toner of each color (e.g., magenta, cyan, yellow, or black). The device state management unit 114 can monitor the remaining toner amount for each color by monitoring the detection signal of the amount remaining for each color.

Storage of Image Data

The icon data storage unit 118 is a memory device such as, an electrically erasable and programmable read-only memory (EEPROM). The icon data storage unit 118 stores icon data that resembles the outer shape (form) of the image forming apparatus 101, and image data visually representing the remaining toner amount. The icon data and the image data will be described below with reference to the other drawings.

Selection of Image Data and Transmission of Data

The image synthesis control unit 112 that has received the status information with respect to the amount of toner remaining from the device state management unit 114 selects image data appropriate for representing the current remaining toner amount from the icon data storage unit 118. After acquisition of the icon data from the icon data storage unit 118, the image synthesis control unit 112 loads the image data and the icon data in a buffer area of the image memory 120 so as to synthesize the image. Then, the image synthesis control unit 112 supplies the synthesized image data with the icon data to the control unit 103. The control unit 103 then converts the image data that is received into, for example, serial data, and transmits the serial data from the communication interface 102 to the personal computer 201 via the network 2.

A configuration of the personal computer 201 will be described below.

For the personal computer 201, a popularized desktop or notebook personal computer can be used. As a general configuration example, the personal computer 201 includes a processor (CPU) 202, a storage device 204, a communication interface 203, a display control unit 205, and an input control unit 206. A display device 301 and an input device 302 are connected to the personal computer 201.

The storage device 204 is a storage device such as a built-in hard disk or memory. The communication interface 203 can be a communication adaptor for connection with the network 2. The display device 301 can be the hardware equivalent to a display or a monitor. The display control unit 205 can be a display adaptor. The input device 302 can be the hardware equivalent to a keyboard, a pointing device, or the like, and the input control unit 206 is its adaptor. Of course, a variety of well-known components can be used for these units.

Operation Example

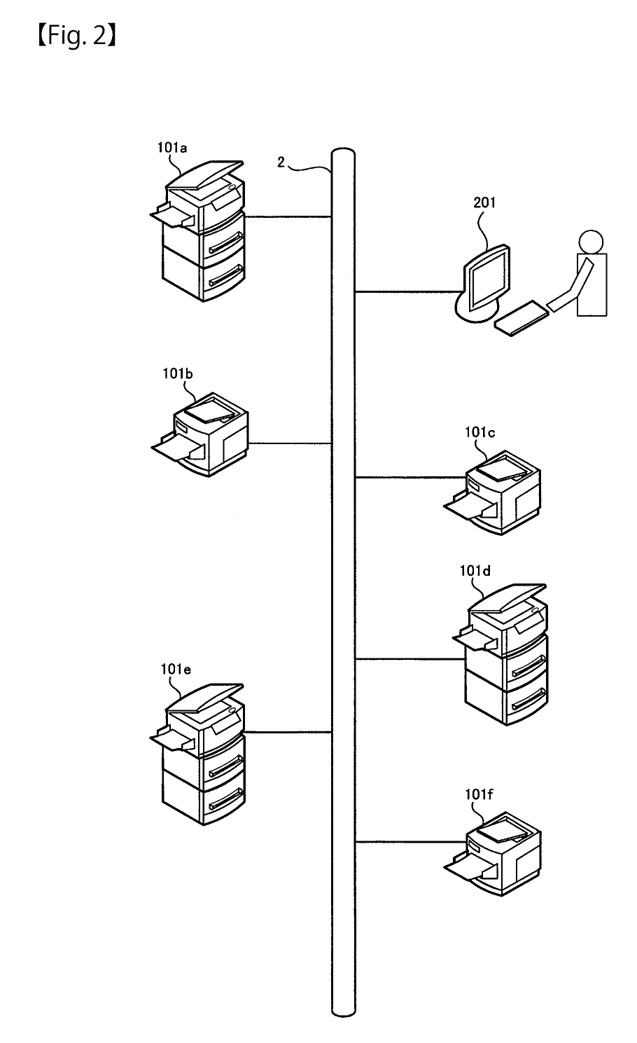

FIG. 2 is a schematic diagram illustrating a configuration example where a plurality of image forming apparatuses 101a to 101f are connected to the network 2. The image forming apparatuses 101a to 101f are similar in configuration to the image forming apparatus 101 shown in FIG. 1, but differ from one another in form. For example, the image forming apparatuses 101a, 101d and 101e are complex machines, MFPs, or the like, while the other image forming apparatuses 101b, 101c and 101f are printers. The personal computer 201 is a desktop personal computer in this example. However, the personal computer 201 may be a notebook personal computer or other device.

LLTD Mapper

In the network environment as described above, it is presumed that the personal computer 201 includes a predetermined operating system (e.g., WindowsVista (registered trademark)). In this case, the personal computer 201 issues a search request in the network 2 by using, for example, link-layer topology discovery (LLTD) (LLTD Mapper). This search request is made in, for example, processing executed by the operating system to visualize a structure of the network 2 as a map.

LLTD Responder

The image forming apparatuses 101a to 101f incorporate response functions corresponding to the LLTD. In other words, the control unit 103 includes a responder (LLTD responder) corresponding to an LLTD communication protocol. Accordingly, when the personal computer 201 issues a multicast search request in the network 2, the control unit 103 of each of the image forming apparatuses 101a to 101f instructs the image synthesis control unit 112 to synthesize image data according thereto.

Synthetic Example of Image Data and Icon Data

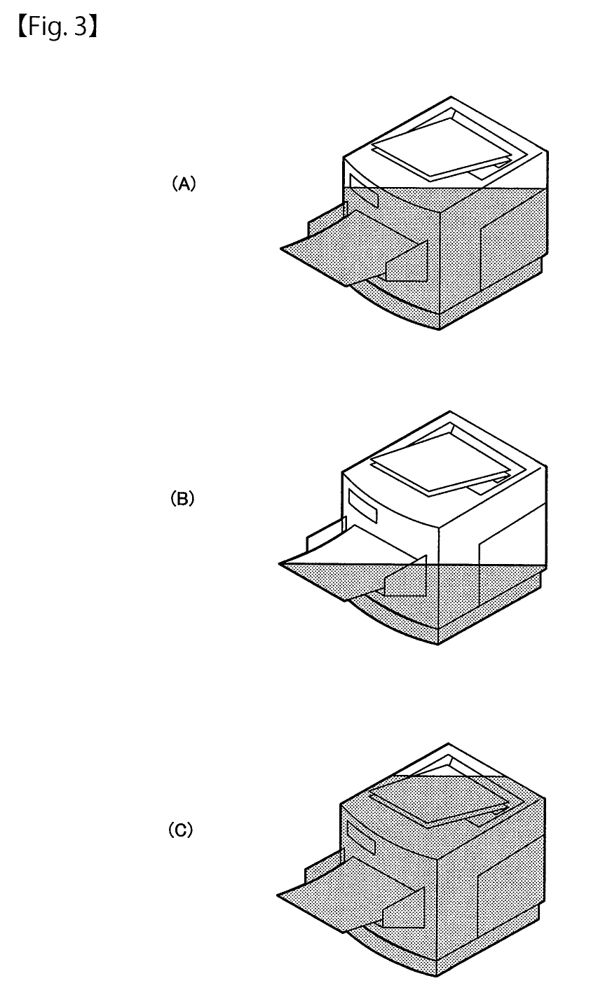

FIGS. 3A to 3C illustrate a plurality of synthetic examples of image data and icon data. For example, in each of the printer-type image forming apparatuses 101b, 101c and 101f, the image synthesis control unit 112 obtains, after receiving information relating to the amount of toner remaining from the device state management unit 114, image data that represents the current amount of toner remaining from the icon data storage unit 118 as described above, and also obtains icon data that illustrates its structure. By performing this operation for the respective toner colors, the synthetic images that are illustrated by way of example in FIGS. 3A to 3C can be obtained.

The synthetic images shown in FIGS. 3A to 3C visually represent the amount of toner remaining for magenta, cyan and yellow. In these examples, icons that resemble the shape of a printer are daubed with these toner colors (magenta, cyan and yellow), and the amount of toner remaining is visually represented based on the area thereof that is colored (the height of the level from bottom to top). For the black toner amount remaining, similarly synthesized image data (not illustrated) is generated. In this case, to improve visibility and design of an icon, black (RGB: 0, 0, 0) is not used, but a somewhat brighter color (e.g., gray) is preferably used as a color to be daubed. The synthesized image data is buffered on the image memory 120 as described above.

Moving Image Data

The image synthesis control unit 112 can generate moving image data (e.g., file of GIF animation form) by using the four pieces of image data synthesized for the respective toner colors. The moving image data generated by the image synthesis control unit 112 is supplied to the control unit 103, and transmitted to the personal computer 201 according to a search request from the personal computer 201.

Display Example

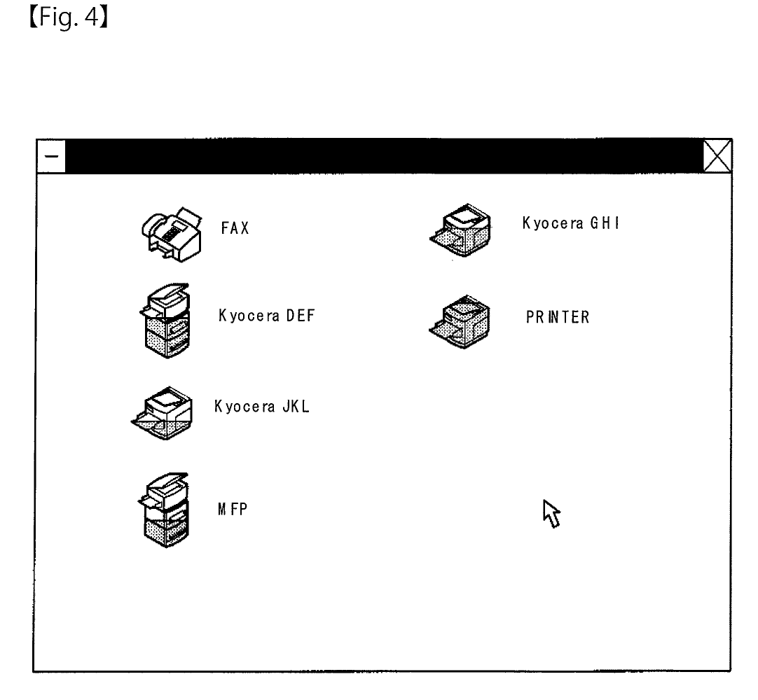

FIG. 4 illustrates an example of an image displayed in the display device 301 of the personal computer 201. The personal computer 201 makes, after receiving the image data, the configuration of the network 2 visible by using the image data. In this example, a screen (window) of a list of printers displays icons representing the image forming apparatuses 101a to 101f. The icons are synthesized with the image data indicating the remaining amounts of toner as described above.

In this case, if the personal computer 201 has received the moving image data, a corresponding icon is displayed in animation form. For example, one icon is displayed so as to be switched, in sequence, through the images of FIG. 3A→FIG. 3B→FIG. 3C. The switching interval is preferably set to a nonredundant period of time (less then one second).

Addition Example of Identification Information or the Like

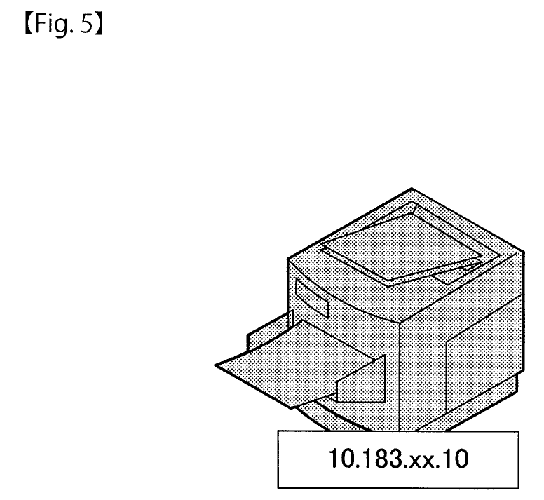

FIG. 5 illustrates an example where character information is added to the image data. When a plurality of similar types of MFPs or printers are present in the network, identification of an individual device may be difficult if an icon is simply displayed. Thus, according to an embodiment, pieces of identification information (IP addresses in this example) of the image forming apparatuses 101a to 101f are added to the image data (or moving image data) generated by the image synthesis control unit 112 to transmit the image data. The personal computer 201 displays icons based on the received image data, and can display the icons in association with the pieces of identification information. The identification information may be a name of an individual device (e.g., printer name) instead of the IP address.

Another Display Example

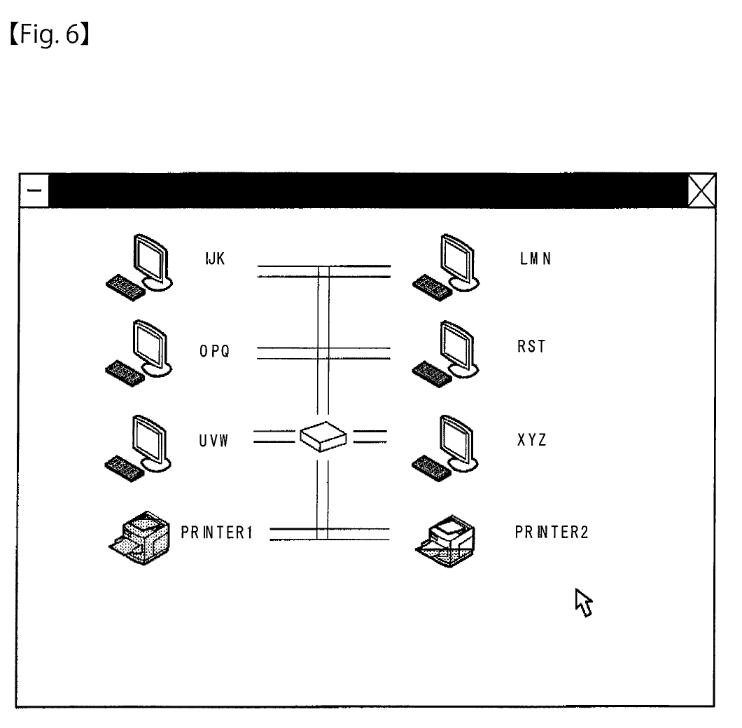

FIG. 6 illustrates another display example where the structure of the network 2 is made visible in the personal computer 201. This example shows a display form similar to a “network map”. Even in the case of displaying the network map in the personal computer 201, the icons can be displayed based on the image data transmitted from the image forming apparatuses 101a to 101f (not all are displayed).

Thus, according to an embodiment, even without the prior storage of any image data in the personal computer 201, transmission of image data from the image forming apparatuses 101a to 101f to the personal computer 201 allows the display of a current state as an icon in the personal computer 201. As a result, a user of the personal computer 201, a network administrator, or the like can easily recognize the status (the remaining amounts of toner of respective colors in this example) of the image forming apparatuses 101a to 101f from the displayed icons.

Even when a new image forming apparatus 101 is added to the network 2 or when any one of the existing image forming apparatuses 101a to 101f is removed, the memory of the personal computer 201 does not have to be updated each time, and thus work loads on the user, the network administrator, or the like can be greatly reduced.

Other State Information

The status detected by the device state management unit 114 is not limited to the amount of toner remaining. Other states and status may be detected. For example, the device state management unit 114 may detect: (1) a current job execution state (being printed or not), (2) a paper jam, and (3) a calibration execution state as types of status information. In this case, the image synthesis control unit 112 may generate moving image data wherein an icon is flashed during job execution, an icon is flashed by an alert color (e.g., red) when there is a paper jam in the printer, or an icon is flashed by a caution color (e.g., yellow) during calibration execution.

It should be noted that the embodiment of the invention set forth above is in no way meant to be limiting and various modifications and changes can be made thereto. For example, the embodiment has been described with respect to a single personal computer 201 as an example. However, the image forming apparatus 101 can transmit image data to a plurality of personal computers 201 connected to the network 2.

Needless to say, the configurations of the image forming apparatus 101 and the personal computer 201 of the above embodiment are only exemplary, and thus can be appropriately modified as may be required.

In an embodiment, the present invention can be summarized as follows. In other words, an image forming apparatus according to an embodiment of the present invention comprises:

a data reception unit for receiving data sent from another electronic device via a predetermined network;

a state detection unit for detecting a current state regarding at least an image forming operation;

a data storage unit for storing a plurality of image data corresponding to a plurality of status beforehand;

a data selection unit for selecting, based on the current status detected by the state detection unit, at least one of the plurality of the image data stored by the data storage unit; and

a data transmission unit for transmitting, when a predetermined request comes from the another electronic device via the predetermined network, the image data selected by the data selection unit to the another electronic device according to the predetermined request.

Further, the state detection unit is capable of detecting the amount of toner remaining to develop a latent image based on the image,

the data storage unit stores a plurality of image data visually representing the amount of the toner remaining, and

the data selection unit may select, based on the amount of the toner remaining that has been detected by the state detection unit, image data visually representing the amount of the toner remaining.

In this case, when the electronic device displays icons or the like based on the image data, the user can easily recognize if there is an issue with respect to the amount of toner remaining from the display state of the icons for the image forming apparatus. Thus, for example, when a plurality of image forming apparatuses are present in the network, the user of the electronic device can transmit data for printing by designating an image forming apparatus where a sufficient amount of toner still remains, as indicated by the display status of each icon. The user can visually determine if the amount of toner remaining is low for a specific image forming apparatus and take appropriate measures such as replenishing the toner. Thus, network management can be improved and made more convenient.

Further, the state detection unit is capable of detecting, so as to form a color image based on the data for printing, the amount remaining for each of a plurality of colors regarding the toner of the plurality of colors,

the data storage unit stores a plurality of image data visually representing the amount of the toner remaining of the each of the plurality of colors,

the data selection unit selects the image data visually representing the amount of the toner remaining of the each of the plurality of colors for the each of the plurality of colors based on the amount of the toner remaining of the each of the plurality of colors detected by the state detection unit, and

the data transmission unit may transmit the image data visually representing the amount of the toner remaining of the each of the plurality of colors selected by the data selection unit as a group of moving image data to the another electronic device.

With this configuration, for example, when the image forming apparatus has toner for four colors (magenta, cyan, yellow, and black) for color printing, the amounts of respective colors remaining can be indicated by four pieces of image data, and these four pieces of image data can be set as a group to constitute moving image data (animation form). The electronic device that has received such moving image data can visually represent the remaining amounts of the respective colors by displaying, for example, a moving image where the four pieces of image data are sequentially switched. Thus, the user of the electronic device or the network administrator can easily determine the toner remaining of each color for each image forming apparatus by viewing such a moving image, and accordingly take appropriate action.

Further, the data storage unit further stores icon data which is image data in the form of the image forming apparatus, and

the data transmission unit may transmit the image data selected by the data selection unit and the icon data in a synthesized state to the another electronic device.

With this configuration, the electronic device can display an icon representing the actual form of the image forming apparatus main body. Thus, visual recognition with respect to which image forming apparatus is being represented by which icon can be improved. By synthesizing image data indicating a current status with the icons, the electronic device can display images which facilitates user's intuitive recognition.

Further, the data transmission unit may transmit identification information for identifying an individual image forming apparatus main body in the network together with the image data to the another electronic device.

In this case, even when a plurality of image forming apparatuses of similar types are present in the network, the electronic device can display each identification information with the icon. Thus, the user can easily recognize each image forming apparatus from the displayed identification information. As a result, convenience can be improved.

Further, the predetermined request which the other electronic device has made via the network is transmitted by a predetermined protocol so as to provide a visualization of the connection structure of the network as a map in an operating system installed in the other electronic device, and

the data transmission unit may communicate according to the predetermined protocol.

When the image forming apparatus functions to respond to the request using the predetermined protocol (responder), in the operating system of the electronic device, image data can be supplied thereby displaying the structure of the network as a map. The electronic device can display this map by using the image data that is received, and display the current state of the image forming apparatus in icon form.

According to other embodiment of the present invention, a device for generating an image, comprises:

a unit for receiving data via a network;

a detection unit for detecting a current status of an image generating device;

a storage unit for storing image data corresponding to a plurality of states;

a selection unit for selecting, based on the current status detected by the detection unit, image data stored by the storage unit; and

a transmission unit for transmitting, when a predetermined request is received via the network, the image data selected by the selection unit to another electronic device according to the predetermined request.

Further, the detection unit is capable of detecting an amount of toner remaining, the storage unit stores image data visually representing the amount of toner remaining; and the selection unit selects, based on the remaining amount of the toner detected, image data that visually represents the amount of toner remaining.

Further, the detection unit is capable of detecting, so as to form a color image based on the image, the remaining amount, for each of a plurality of colors, of toner;

the storage unit stores a plurality of image data visually representing the amount of toner remaining for each of the plurality of colors;

the selection unit selects the image data visually representing the amount of toner remaining for each of the plurality of colors detected by the detection unit; and

the transmission unit transmits the image data visually representing the amount of toner remaining for each of the plurality of colors selected by the selection unit as a group of moving image data to the other electronic device.

Further, the storage unit stores icon data that can create a display that is representative of the device, and the transmission unit transmits the image data selected by the selection unit and the icon data to another electronic device.

Further, the transmission unit transmits identification information for identifying an individual device main body in the network together with the at least one of the plurality of the image data to the other electronic device.

Further, the predetermined request from the other electronic device made via the network is transmitted by a predetermined protocol so as to visualize a connection structure of the network as a map in an operating system installed in the other electronic device; and

the data transmission unit is capable of communicating according to the predetermined protocol.

Further, the transmission unit transmits information for creating an image that represents an image generating device to another electronic device.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image forming apparatus, comprising:
a data reception unit for receiving data sent from another electronic device via a network;
a state detection unit for detecting a current status regarding an image forming operation;
a data storage unit for storing a plurality of image data corresponding to a plurality of states;
a data selection unit for selecting, based on the current status detected by the state detection unit, at least one of the plurality of the image data stored by the data storage unit; and
a data transmission unit for transmitting, when a predetermined request is received from the another electronic device via the network, the image data selected by the data selection unit to the other electronic device according to the predetermined request.

2. The image forming apparatus according to claim 1, wherein:
the state detection unit is capable of detecting an amount of toner remaining to develop a latent image formed based on the image;
the data storage unit stores a plurality of image data visually representing the amount of toner remaining; and
the data selection unit selects, based on the remaining amount of the toner detected by the state detection unit, at least appropriate one of the plurality of the image data visually representing the amount of toner remaining.

3. The image forming apparatus according to claim 2, wherein:
the state detection unit is capable of detecting, so as to form a color image based on the image, the remaining amount, for each of a plurality of colors, of toner;
the data storage unit stores a plurality of image data visually representing the amount of toner remaining for each of the plurality of colors;
the data selection unit selects the image data visually representing the amount of toner remaining for each of the plurality of colors detected by the state detection unit; and
the data transmission unit transmits the image data visually representing the amount of toner remaining for each of the plurality of colors selected by the data selection unit as a group of moving image data to the other electronic device.

4. The image forming apparatus according to claim 1, wherein:
the data storage unit further stores icon data display representative form an image forming apparatus main body; and
the data transmission unit transmits the image data selected by the data selection unit and the icon data in a synthesized state to the other electronic device.

5. The image forming apparatus according to claim 1, wherein the data transmission unit transmits identification information for identifying an individual image forming apparatus main body in the network together with the at least one of the plurality of the image data to the other electronic device.

6. The image forming apparatus according to claim 1, wherein:
the predetermined request from the other electronic device made via the network is transmitted by a predetermined protocol so as to visualize a connection structure of the network as a map in an operating system installed in the another electronic device; and
the data transmission unit is capable of communicating according to the predetermined protocol.

7. A device for generating an image, comprising:
a unit for receiving data via a network;
a detection unit for detecting a current status of an image generating device;
a storage unit for storing image data corresponding to a plurality of states;
a selection unit for selecting, based on the current status detected by the detection unit, image data stored by the storage unit; and
a transmission unit for transmitting, when a predetermined request is received via the network, the image data selected by the selection unit to another electronic device according to the predetermined request.

8. The device according to claim 7, wherein:
the detection unit is capable of detecting an amount of toner remaining;
the storage unit stores image data visually representing the amount of toner remaining; and
the selection unit selects, based on the remaining amount of the toner detected, image data that visually represents the amount of toner remaining.

9. The device according to claim 8, wherein:
the detection unit is capable of detecting, so as to form a color image based on the image, the remaining amount, for each of a plurality of colors, of toner;
the storage unit stores a plurality of image data visually representing the amount of toner remaining for each of the plurality of colors;
the selection unit selects the image data visually representing the amount of toner remaining for each of the plurality of colors detected by the detection unit; and
the transmission unit transmits the image data visually representing the amount of toner remaining for each of the plurality of colors selected by the selection unit as a group of moving image data to the other electronic device.

10. The device according to claim 7, wherein:
the storage unit stores icon data that can create a display that is representative of the device; and
the transmission unit transmits the image data selected by the selection unit and the icon data to the other electronic device.

11. The device according to claim 7, wherein:
the transmission unit transmits identification information for identifying an individual device main body in the network together with the at least one of the plurality of the image data to the other electronic device.

12. The device according to claim 7, wherein:
the predetermined request from the other electronic device made via the network is transmitted by a predetermined protocol so as to visualize a connection structure of the network as a map in an operating system installed in the other electronic device; and
the data transmission unit is capable of communicating according to the predetermined protocol.

13. The device according to claim 7, wherein the transmission unit transmits information for creating an image that represents an image generating device to the other electronic device.
